(19) United States
(12) Patent Application Publication
(10) Pub. No.: US 2007/0282903 A1
(43) Pub. Date: Dec. 6, 2007

(54) MP3 PLAYING WITH SIMPLIFIED USER INTERACTIVE GENERATION AND NAVIGATION OF PLAYLISTS

(76) Inventors: LEUGIM A. BUSTELO, Austin, TX (US); MERLE DOUGLAS STERLING, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/421,117

(22) Filed: May 31, 2006

(51) Int. Cl. G06F 17/00

(52) U.S. Cl. 707/104.1

(57) ABSTRACT

In sequentially playing a first playlist of a sequence of a plurality of stored MP3 files arranged according to a selected attribute of the files, there is provided the combination of means enabling a user to selectively branch, at a selected MP3 file departure node in the sequence, to sequentially playing a second playlist of a sequence of a plurality of the stored MP3 files arranged according to an attribute different from the selected attribute, together with means for storing the departure node and means for enabling the user to return to the departure node to continue the playing of the first playlist from departure node.

### CROSS-REFERENCE TO RELATED PATENT APPLICATION

The following copending patent application, which is assigned to the same assignee as the present invention, covers subject matter related to the subject matter of the present patent application: Application (Attorney Docket No. AUS920060166) filed on the same date as the present Application, entitled: Accessing and Purchasing of MP3 Files and Playlists From Provider Sources Via Communication Networks, L. A. Bustelo et al., and hereby incorporated by reference.

### TECHNICAL FIELD

The present invention relates to the playing of music files on MP3 players, and particularly to simplified generation and navigation through playlists of MP3 music files.

### BACKGROUND OF RELATED ART

Over the past few years, the consumer electronics industry has witnessed an almost unprecedented demand for MP3 players and the music titles or MP3 files playable in sequences, i.e. playlists, on such players. Music titles and/or MP3 files refer to recorded musical presentations from two or three minute tunes or units up to and including usually album-sized recordings in the order of one hour in length. MP3 is shorthand for MPEG, Level 3. MP3 is, to a great extent, replacing the Compact Disc as today's reigning music distribution standard with dozens of MP3 player devices saturating the consumer marketplace. MP3 is a standard about which an industry has been gathered. MP3 takes advantage of the high compression afforded under the MPEG audio standard and uses it as the basis for a file system that serves as a basis for today's MP3 hardware. The advantage of MP3 is simply compression. It fits audio files into about 1/20 of the space raw digital audio would require. As a result, music that would nominally require a 50 MB file under the WAV format only takes about 2-3 MB. Smaller files mean less transmission time so that entire albums can reasonably be sent across the Internet. In solid state memory MP3 players, substantial lengths of music (a few hours or more), may be encoded into the solid state memory and carried about in a no-moving-parts player, such as the iPod M. It is these solid memory players that are today's MP3 music title portable players. Better still, by squeezing the size of the MP3 file, the data rate required for playing back a file in real-time can be similarly reduced. Instead of requiring the approximately 1.2 mbits/sec to move two CD-quality audio channels, MP3 files require only 40 kbits/sec for near CD quality playback. In the most popular MP3 players, the MP3 music titles or files are currently stored in solid state memories with a capacity in the order of 1 gigabyte (GB), which equates to about 240 tunes or songs or about twenty CDs. For users requiring an even greater capacity, the memory in the MP3 player may be supplemented by a compact hard disk drive incorporated into the player that increases capacity in the order of 10 to 50 gigabytes.

All of this great capacity for music files or titles presents the user carrying his little MP3 player with the burden of riches. He is virtually carrying a huge library of music files on his back. The MP3 industry has the task of enabling the user, particularly of a portable MP3 player, to conveniently sort or navigate through his potentially huge library of stored MP3 files to find and play the files that he desires at a particular time without having the burden of navigating and generating playlists intruding upon the pleasure of his listening.

### SUMMARY OF THE PRESENT INVENTION

The present invention provides an implementation that enables a user of an MP3 player to find and play the playlists of files that he desires at a particular time without having the burden of navigating and generating playlists intruding upon the pleasure of his listening. The invention is directed to conventional means for sequentially playing a first playlist of a sequence of a plurality of stored MP3 files arranged according to a selected attribute of the files. There is provided the combination of means enabling a user to selectively branch, at a selected MP3 file departure node in the sequence, to sequentially play a second playlist of a sequence of a plurality of the stored MP3 files arranged according to an attribute different from the selected attribute, together with means for storing the departure node; and means for enabling the user to return to the departure node to continue the playing of the first playlist from departure node.

According to a further aspect of the invention, there are further means enabling a user to selectively branch, at a selected second departure node in the second playlist sequence, to sequentially playing a third playlist of a sequence of a plurality of the stored MP3 files arranged according to an attribute different from the attribute of the second playlist, together with means for storing the second departure node and means for enabling the user to return to a selected departure node to continue the playing of the departed playlist from said departure node. While the above functions have been described with respect to individual attributes determining the playlists, a set of a plurality of attributes may be used to define or determine the playlists.

It should be noted that the term MP3 files has been used herein to cover compressed digital media, e.g. audio file currently in popular usage to create playlists. MP3 files are lossy compression files. Other equivalent compressed files that may be used are ACC, a lossy compression file used by Apple Corp., WMA, a lossy compression file used by Microsoft, and WAV, a lossy-less compression file common in devices with Windows implementations.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic illustration of the system for controlling an MP3 player device that may used in the practice of the present invention;

FIG. 2 is the user interface portion of a conventional portable MP3 player device that may be used in the practice of the present invention;

FIG. 3 is the display screen on a conventional MP3 player displaying several attributes of an MP3 file being currently played from a playlist;

FIG. 4 illustrates a display interface that was brought up when a viewer or user at a portable MP3 player wishes to branch from the playlist being played (determined by an initial selected attribute) to a playlist determined by a different attribute selected from the attributes of the MP3 file being played in FIG. 3;

FIG. 5 is an illustrative flowchart describing the setting up of the programming functions to form the implementation of enabling a user to selectively branch from a selected MP3 file departure node in a sequence (playlist) to a second playlist arranged based upon a different attribute in accordance with the present invention; and

FIG. 6 is a flowchart of an illustrative run of the program set up according to FIG. 5.

### DETAILED DESCRIPTION OF THE PREFERRED EMBODIMENT

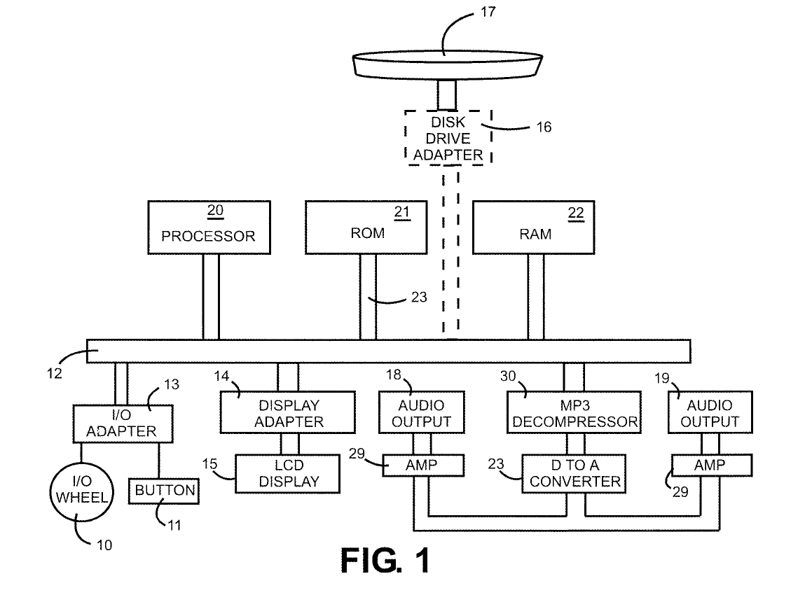

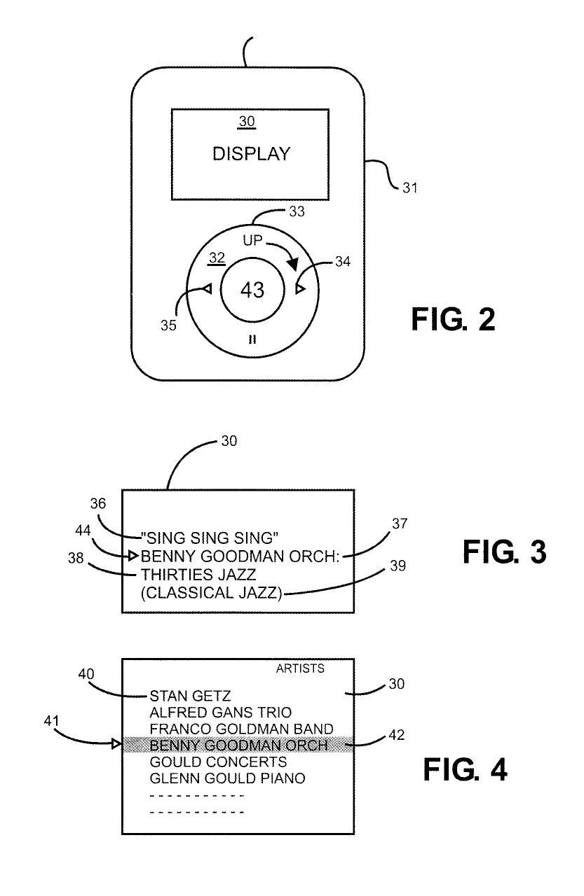

Referring to FIG. 1, a typical data processing system is shown that may function as the system for the conventional players for MP3 files on which the present invention may be implemented. For purposes of the present illustration, the MP3 player will be a portable handheld type player such as the iPod™. The control system for the player system may be embodied in the controller integrated circuit chips within the player housing that may provide specific purpose logic to control the access and logic as follows. These logic or control chips contain data processors 20, operating systems stored in random access memory (RAM) 22 (about 2 MB of RAM is typically provided) and a read only memory (ROM) 21 that provides the primary programmable memory. This programmable ROM may be an EEPROM, e.g. flash EEPROM 10. All of the routines and programs that control the player may also be conventionally stored in this flash EEPROM 21. These include operating systems and built-in applications that may also be conventionally stored in the RAM. The program of the present invention may conveniently be included in this EEPROM. The logic or controller chip also contains the system bus 12 connecting the elements of the invention. The player is powered by a conventional portable power supply (not shown) that is connected through the system bus 12. Under the control of processor 20, the content, i.e. MP3 files stored in ROM 21 (EEPROM up to 1 gigabyte), is to be played under the control of programs such as that of the present invention that may also be stored in ROM 21 or in RAM 22. In the higher storage content MP3 player devices, there may be supplementary portable disk drive storage in hard drive 17 connected to bus 12 through disk drive adapter 16. In any case, the stored MP3 files are moved via bus 12 from storage to RAM 22 wherein the playlists are formed and sequentially played. The MP3 data is decompressed through decompressor 30. The decompressor 30 may be included in the above-described logic or control chip. The decompressed digital data representative of the MP3 file being presented is put through a digital to analog converter 23 and then coupled to audio output devices 18 and 19, respectively, through amplifiers 29. The audio output may be in the form of speakers or conventional earphones. The conventional user interface through which the present invention may be implemented includes a conventional finger operated I/O wheel 10 and associated buttons (subsequently described relative to FIG. 2) connected via I/O adapter 13 to bus 12, as well as LCD display 15 connected via display adapter 14.

Referring now to FIG. 2, the present invention will be described with respect to a portable MP3 file playing device such as the iPod™. However, it should be understood that while the benefits of the present invention are most advantageous to portable players, the ease of use conveniences in the navigation through MP3 playlists are also effective in stationary players, such as desktop computers with Apple or Windows operating systems. MP3 player 31 has LCD display 30 and I/O selection wheel 32 that may be rotated as shown in navigating through menus of selections while center button 43 is pressed to make the selections. The wheel also contains a set of push points, i.e. buttons: up 33 for advancing through a set of menus, and points 33 and 34 for stepping back and forward respectively. It also has a pause (11) point.

To illustrate a simple operation of the invention including programming, which will be described in greater detail with respect to FIGS. 3 and 4, let us assume that the user has selected a playlist of MP3 titles or files that are currently being played in sequence. The current selected attribute is random, i.e. the system selects and plays MP3 files in a random order. Screen 30 in FIG. 4 shows the MP3 file being currently played and four of its attributes: title of music song 36, artist 37, album 38 and genre 39.

At the point that the song is being played, the user/listener may decide to branch off to and pursue a playlist based upon one of the attributes 36 through 39. In the present case, as indicated by arrowhead 44 moved by any method described above, the listener has decided that he would like to listen to a playlist of the artist 37, “Benny Goodman Orch.” To confirm the selection, the program has brought up display screen 30 in FIG. 4 that is the artist menu 40 with the selected artist 41 already indicated by highlighting 42. The user pushes the central button 43 to confirm and the program now puts together, and commences to play, a playlist of the artist that in effect branches from the playlist node shown in FIG. 3 but based upon the artist rather than the original random attribute. As the artist based playlist is now sequentially played, display screens, such as that of FIG. 3, will be presented for each MP3 file being played. From any one of this sequence of display screens the listener is enabled to pursue still another branch to another playlist based upon another attribute shown in FIG. 3. For example, if after listening to a string of Benny Goodman songs, the listener decides that he is really interested in hearing more MP3 files from the “Classical Jazz” 39 genre attribute, the listener proceeds as described above to branch to such a playlist. The program tracks all of the playlists, nodes and branches so the listener through navigation through the interface of FIGS. 2 through 4 may return to any branch node and resume the playing of the switched from playlist.

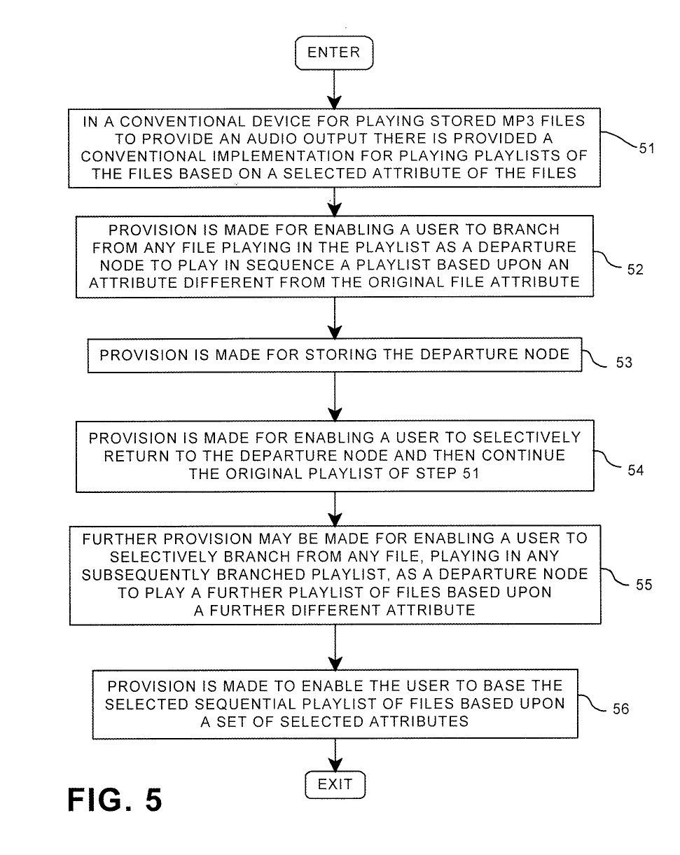

Now, with reference to the programming shown in FIG. 5, there will be described how the system and programs of the present invention are set up. In a conventional device for playing stored MP3 files, there is provided a conventional implementation for playing playlists of the files based upon a selected attribute of the files, step 51. Provision is made for enabling the user/listener to branch from any file playing in the playlist, as a departure node, to play in sequence, a playlist based upon an attribute different from the original playlist attribute, step 52. Provision is made for storing each such departure node, step 53. Provision is also made for enabling a user to selectively return to the departure node and then to continue to play the departed from playlist, step 54. In addition, provision may be made enabling a user to selectively branch from any file playing in any subsequently branched to playlist, as a departure node to play a further playlist of files based upon a further different attribute, step 55. Provision may also be made to enable the user to base any selected playlist of files upon a set of selected attributes, e.g. “Benny Goodman Orch” and “Classical Jazz”, step 56.

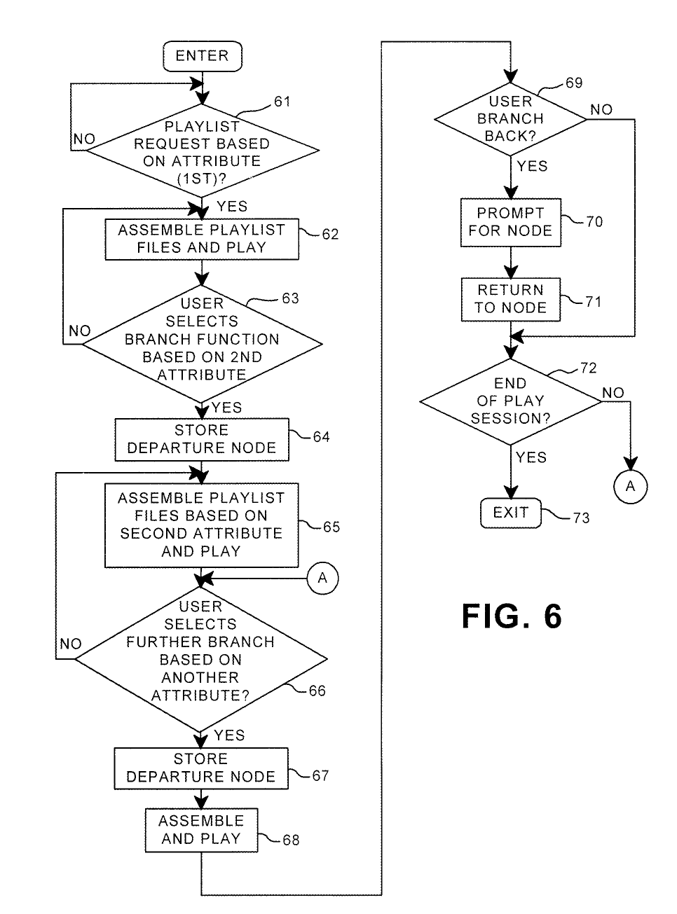

With reference to the flowchart of FIG. 6, a simplified illustrative run of the process set up in FIG. 5 will be described. An initial determination is made, step 61, as to whether a playlist based upon a first attribute has been requested. If Yes, the playlist is assembled and played, step 62. Then, as the playlist is played, a determination is continually made as to whether the user has selected a playlist branch function based upon another or second attribute, step 63. If No, the playing, step 62, is continued. If Yes, the departure node is stored, step 64, and a playlist based on the second attribute is assembled and played, step 65. Then, as this next playlist is played, a determination is continually made as to whether the user has selected a further playlist branch function based upon still another attribute, step 66. If No, the playing, step 65, is continued. If Yes, the departure node is stored, step 67, and a playlist based on this further attribute is assembled and played, step 68. Now, with respect to a return to a departure node function, a determination is continually made as to whether the user wishes to branch back to a departure node, step 69. If Yes, the user is prompted for the entry of the departure node, step 70, and the node is returned to from which the departed playlist is continued to be played, step 71. At any point a determination may be made as to whether the playing session is at an end. If Yes, the session is exited, step 73. If No, the playing is branched back via branch “A” to step 66 from which the playing continues as heretofore described.

Although certain preferred embodiments have been shown and described, it will be understood that many changes and modifications may be made therein without departing from the scope and intent of the appended claims.

What is claimed is:

1. In a portable device for playing stored MP3 files, the improvement comprising:
means for sequentially playing a first playlist of a sequence of a plurality of said stored MP3 files arranged according to a selected attribute of said files;
means enabling a user to selectively branch, at a selected MP3 file departure node in said sequence, to sequentially playing a second playlist of a sequence of a plurality of said stored MP3 files arranged according to an attribute different from said selected attribute;
means for storing said departure node; and
means for enabling the user to return to said departure node to continue the playing of said first playlist from said departure node.

2. The portable device for playing stored MP3 files of claim 1 further including:
means enabling a user to selectively branch, at a selected second departure node in said second playlist sequence, to sequentially playing a third playlist of a sequence of a plurality of said stored MP3 files arranged according to an attribute different from the attribute of said second playlist;
means for storing said second departure node; and
means for enabling the user to return to selected departure node to continue the playing of the departed playlist from said departure node.

3. The portable device for playing stored MP3 files of claim 1 wherein said attribute and said different attribute, each include a set of at least one attribute.

4. The portable device for playing stored MP3 files of claim 2 wherein said attribute different from the attribute of said second playlist includes a set of at least one attribute.

5. The portable device for playing stored MP3 files of claim 3 wherein said stored MP3 files are audio files, and said means for playing are audio.

6. A method for playing stored compressed audio files in a portable device comprising:
sequentially playing a first playlist of a sequence of a plurality of said stored compressed audio files arranged according to a selected attribute of said files;
enabling a user to selectively branch, at a selected compressed audio file departure node in said sequence, to sequentially playing a second playlist of a sequence of a plurality of said stored compressed audio files arranged according to an attribute different from said selected attribute;
storing said departure node; and
enabling the user to return to said departure node to continue the playing of said first playlist from said departure node.

7. The method for playing stored compressed audio files of claim 6 wherein said compressed audio files are MP3 files.

8. The method for playing stored MP3 files of claim 7 further including the steps of:
enabling a user to selectively branch, at a selected second departure node in said second playlist sequence, to sequentially playing a third playlist of a sequence of a plurality of said stored MP3 files arranged according to an attribute different from the attribute of said second playlist;
storing said second departure node; and
enabling the user to return to selected departure node to continue the playing of the departed playlist from said departure node.

9. The method for playing stored MP3 files of claim 7 wherein said attribute and said different attribute, each include a set of at least one attribute.

10. The method for playing stored MP3 files of claim 8 wherein said attribute different from the attribute of said second playlist includes a set of at least one attribute.

11. A computer program having code recorded on a computer readable medium for playing stored compressed audio files in a portable device comprising:
means for sequentially playing a first playlist of a sequence of a plurality of said stored compressed audio files arranged according to a selected attribute of said files;
means enabling a user to selectively branch, at a selected compressed audio file departure node in said sequence, to sequentially playing a second playlist of a sequence of a plurality of said stored compressed audio files arranged according to an attribute different from said selected attribute;
means for storing said departure node; and
means for enabling the user to return to said departure node to continue the playing of said first playlist from said departure node.

12. The computer program of claim 11 wherein said stored compressed audio files are MP3 files.

13. The computer program of claim 12 further including:
means enabling a user to selectively branch, at a selected second departure node in said second playlist sequence, to sequentially playing a third playlist of a sequence of a plurality of said stored MP3 files arranged according to an attribute different from the attribute of said second playlist;
means for storing said second departure node; and
means for enabling the user to return to selected departure node to continue the playing of the departed playlist from said departure node.

14. The computer program of claim 12 wherein said attribute and said different attribute, each include a set of at least one attribute.

15. The computer program of claim 13 wherein said attribute different from the attribute of said second playlist includes a set of at least one attribute.

16. In a portable device for playing stored MP3 files, a computer controlled user display interface comprising:
means for sequentially playing a first playlist of a sequence of a plurality of said stored MP3 files arranged according to a selected attribute of said files;
means enabling a user to selectively branch, at a selected MP3 file departure node in said sequence, to sequentially playing a second playlist of a sequence of a plurality of said stored MP3 files arranged according to an attribute different from said selected attribute;
means for storing said departure node; and
means for enabling the user to return to said departure node to continue the playing of said first playlist from said departure node.

17. The portable device for playing MP3 files display interface of claim 16 further including:
means enabling a user to selectively branch, at a selected second departure node in said second playlist sequence, to sequentially playing a third playlist of a sequence of a plurality of said stored MP3 files arranged according to an attribute different from the attribute of said second playlist;
means for storing said second departure node; and
means for enabling the user to return to selected departure node to continue the playing of the departed playlist from said departure node.

18. The portable device for playing MP3 files display interface of claim 16 wherein said attribute and said different attribute, each include a set of at least one attribute.

19. The portable device for playing stored MP3 files display interface of claim 17 wherein said attribute different from the attribute of said second playlist includes a set of at least one attribute.

20. The portable device for playing stored MP3 files display interface of claim 18 wherein said stored MP3 files are audio files, and said means for playing are audio.
